(19) United States
(12) Patent Application Publication
(10) Pub. No.: US 2020/0409432 A1
(43) Pub. Date: Dec. 31, 2020

(54) SENSOR HUB SWITCHES

(71) Applicant: Hewlett-Packard Development Company, L.P., Spring, TX (US)

(72) Inventors: Dimitre Mehandjiysky, Spring, TX (US); Syed S. Azam, Spring, TX (US)

(73) Assignee: Hewlett-Packard Development Company, L.P., Spring, TX (US)

(21) Appl. No.: 16/976,588

(22) PCT Filed: Apr. 13, 2018
(86) PCT No.: PCT/US2018/027577

§ 371 Date: Aug. 28, 2020

(51) Int. Cl. G06F 1/16

(52) U.S. Cl. CPC G06F 1/1683; G06F 1/1686

(57) ABSTRACT

Sensor hub switches are described herein. In one example, a device can include a sensor hub moveable between a first position and a second position and a power switch to be deactivated by the sensor hub when the sensor hub is at the second position.

### BACKGROUND

Computing devices can utilize a plurality of sensors. For example, computing devices can be coupled to sensors such as a camera, microphone, motion sensor, etc. The sensors coupled to a computing device can utilize electrical power from the computing device. For example, the power supply for the computing device can be utilized to provide electrical power to the sensors. In some examples, the plurality of sensors can be utilized to capture audio and/or video data of the surrounding area of the computing device and/or plurality of sensors.

### BRIEF DESCRIPTION OF THE DRAWINGS

FIG. 1 illustrates an example device for a sensor hub switch consistent with the present disclosure.

FIG. 2 illustrates an example device for a sensor hub switch consistent with the present disclosure.

FIG. 3 illustrates an example device for a sensor hub switch consistent with the present disclosure.

FIG. 4 illustrates an example system for a sensor hub switch consistent with the present disclosure.

FIG. 5 illustrates an example system for a sensor hub switch consistent with the present disclosure.

FIG. 6 illustrates an example system for a sensor hub switch consistent with the present disclosure.

### DETAILED DESCRIPTION

A sensor hub can be a device that includes a plurality of sensors The plurality of sensors can include, but are not limited to a camera, a microphone, an infrared (IR) sensor, a depth sensor, an ambient light sensor, and an eye-tracking sensor. For example, a sensor hub can be a device that includes a camera and a microphone to receive inputs from a surrounding area of the sensor hub. In some examples, the sensor hub can be utilized to record audio and video for a computing device. For example, the sensor hub can be utilized to record a video or audio message of a user. In this example, the recorded video or audio message can be sent to a different computing device through a wired or wireless network. The sensor hub can be a device that can potentially be hacked or utilized by an unauthorized user through the computing device. Even when the sensor hub is turned off by the computing device, the sensor hub can still be vulnerable to hackers or unauthorized users if the hacker or unauthorized user accesses the computing device. For example, an unauthorized user can utilize the computing device or communication with the computing device to activate the sensor hub without the knowledge of an authorized user. In this way, an authorized user can be subject to an invasion of privacy by believing the sensor hub is off when it was remotely turned on by an unauthorized user.

In some examples, the sensor hub can be a moveable sensor hub between a first position that exposes the plurality of sensors and a second position that covers the plurality of sensors. In these examples, the second position can be utilized when the sensor hub is not in use. The second position can be a covered position to block or partially block the plurality of sensors from receiving inputs. However, a portion of the plurality of sensors may still be operable and therefore susceptible to hackers or unauthorized users even when the sensor hub is in the second position. To address these issues, the systems and devices for sensor hub switches described herein can physically disconnect the sensor hub from a power source or power supply when the sensor hub is in the second position and provide additional security against hackers utilizing the plurality of sensors when the sensor hub is not in use.

A number of systems and devices for sensor hub switches are described herein. In some examples, a device can include a sensor hub moveable between a first position and a second position and a power switch to be activated by the sensor hub at the first position and deactivated by the sensor hub at the second position. As used herein, a sensor hub can be a device that includes a number of sensors and a sensor hub bay can be an enclosure or aperture to receive the sensor hub. As described herein, the sensor hub bay can be utilized to protect the sensor hub from external forces such as debris. That is, the sensor hub can be moveable between an exterior portion of the sensor hub bay and an interior portion of the sensor hub bay.

In another example, a system for sensor hub switches can include a sensor hub bay that includes a power switch and a sensor hub moveable between a first position within the sensor hub bay and a second position outside the sensor hub bay. In this example, the sensor hub may deactivate the power switch when the sensor hub is in the first position and may activate the power switch when the sensor hub is in the second position. As used herein, a power switch can be activated when the power switch provides an electrical connection between the sensor hub and a power supply. As used herein, the power switch can be deactivated when the power switch provides a physical disconnection that prevents electrical power from being provided to the sensor hub by the power supply. That is, deactivate includes disconnecting a device such as a sensor hub from a power supply to prevent electrical power from being provided to the device. In addition, activate includes connecting a device such as a sensor hub to a power supply to provide electrical power to the device.

In some examples, the sensor hub can be coupled to an electronic device that includes a sensor hub bay. In some examples, the electronic device can include, but is not limited to a computing device, a monitor, a smart tv, a tablet, and/or a mobile device. As used herein, a sensor hub bay can include an enclosure or aperture to receive the sensor hub. For example, a sensor hub bay can include an opening to a housing or recessed portion of the electronic device to receive the sensor hub. For example, the sensor hub bay can include a recessed portion of the electronic device that can cover a portion or the entire area of the sensor hub. In some examples, the sensor hub can be coupled to the sensor hub bay of the electronic device by an actuator to allow the sensor hub to move from a position within the sensor hub bay to a position outside the sensor hub bay.

In some examples, the systems and devices for sensor hub switches can include a power switch that can interact with the sensor hub when the sensor hub changes from a first position to a second position. For example, the sensor hub can physically interact with the power switch to deactivate the power switch and/or break an electrical connection to the sensor hub when the sensor hub is moved to a position within the sensor hub bay. That is, the power switch can be positioned within the sensor hub bay to disconnect power from the sensor hub when the sensor hub is positioned within the sensor hub bay. In this way, the sensor hub is physically disconnected from power and data communications which can further prevent a hacker or unwanted user from activating the sensor hub when the sensor hub is positioned within the sensor hub bay.

Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

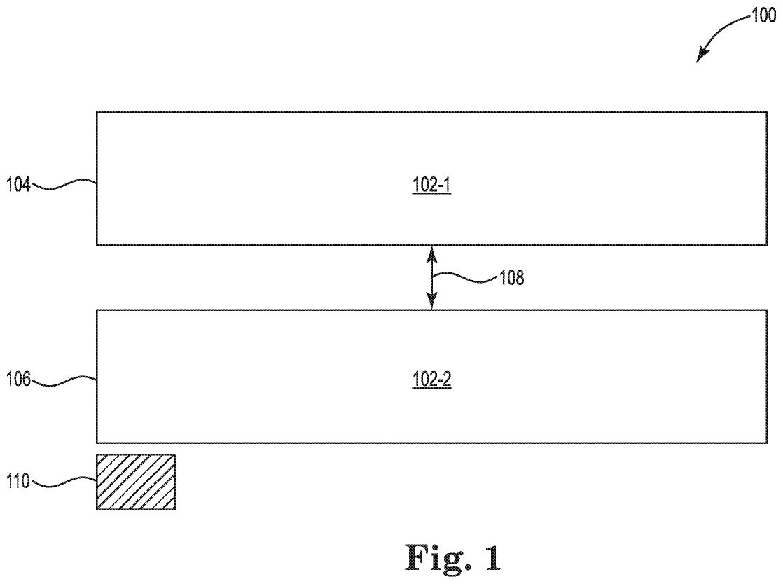

FIG. 1 illustrates an example device 100 for a sensor hub switch. The device 100 can include a sensor hub 102-1, 102-2. As described herein, the sensor hub 102-1, 102-2 can be a device that includes a plurality of sensors. For example, the sensor hub 102-1, 102-2 can include a device with a camera, microphone, and infrared camera. In some examples, the sensor hub 102-1, 102-2 can be moveable between a first position 104 and a second position 106. As used herein, the sensor hub 102-1, 102-2 may be a single device that is moveable between the first position 104 represented by sensor hub 102-1 to a second position 106 represented by sensor hub 102-2.

In some examples, the sensor hub 102-1, 102-2 can be moveable along an axis. For example, the axis can be a linear axis when the sensor hub 102-1, 102-2 moves from the first position 104 to the second position 106. In some examples, the second position 106 can be a position within a sensor hub bay and the first position 104 can be a position outside the sensor hub bay. As used herein, the sensor hub bay can include an aperture or space to receive the sensor hub 102-1. In some examples, the sensor hub 102-1 at the first position 104 can be in an active position where the plurality of sensors of the sensor hub 102-1 are exposed to the environment surrounding the device 100. In other examples, the sensor hub 102-2 at the second position 106 can be in an inactive position where the plurality of sensors of the sensor hub 102-2 are covered by the sensor hub bay.

In some examples, the device 100 can include a power switch 110. The power switch 110 can be coupled to a power supply at a first contact such as an input contact and coupled to the sensor hub 102-1, 102-2 at a second contact such as an output contact. As used herein, a power supply can include an electrical device which supplies electric power to an electrical load. In some examples, the power switch 110 can be an electromechanical switch that can be activated to provide an electrical connection through the power switch 110 and/or deactivated to prevent an electrical connection through the power switch 110. As used herein, an electrical connection can include a device or element that allows the flow of electrons or a flow of electricity between at least two points. In some examples, the power switch 110 can be utilized to prevent or cut-off an electrical connection to the sensor hub 102-1, 102-2 and/or utilized to prevent or cut-off a data connection to the sensor hub 102-1, 102-2. As used herein, a data connection includes a communication connection that can transmit or receive data communication. For example, a data connection can include a wired or wireless connection that can be utilized to send and/or receive data packets.

In some examples, the power switch 110 can be a contact switch that can be activated and deactivated by physical contact with a button coupled to the power switch 110. For example, the sensor hub 102-2 can be in contact with a button coupled to the power switch 110 to deactivate the power switch 110 when the sensor hub 102-2 is in the second position 106. In another example, the sensor hub 102-1 may not be in contact with the button coupled to the power switch 110 and activate the power switch 110 when the sensor hub 102-1 is in the first position 104. That is, when the sensor hub 102-1, 102-2 is in the first position 104 the power switch 110 can be activated to provide power to the sensor hub 102-1, 102-2 and when the sensor hub 102-1, 102-2 is in the second position 106 the power switch 110 can be deactivated to prevent power to the sensor hub 102-1, 102-2. In this way, the sensor hub 102-1, 102-2 may be physically disconnected from a power supply when the sensor hub 102-1, 102-2 is in the second position 106. As used herein, physically disconnected can include a physical break of the electrical connection between the sensor hub 102-1, 102-2 and a power supply.

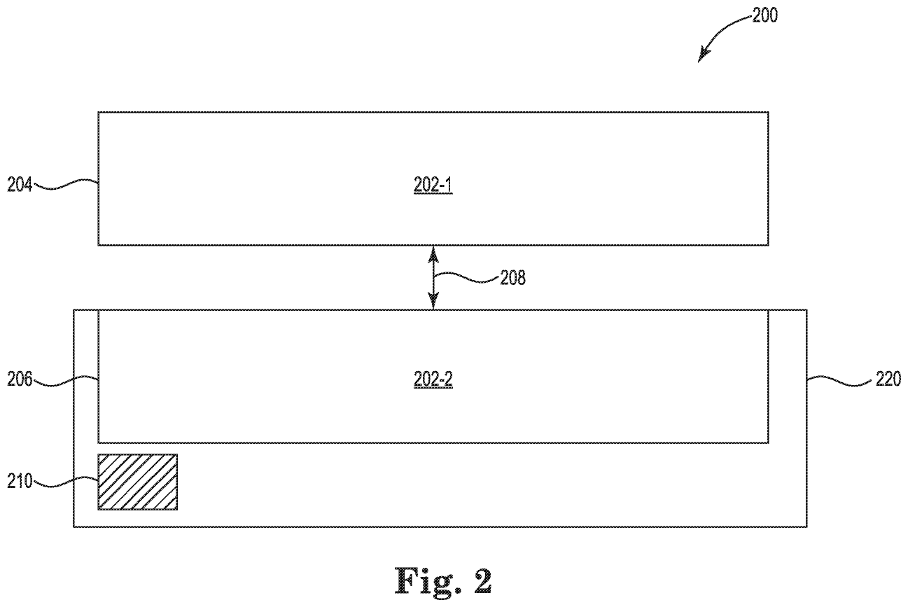

FIG. 2 illustrates an example device 200 for a sensor hub switch consistent with the present disclosure. In some examples, the device 200 can include a sensor hub 202-1, 202-2 that can be moveable between a first position 204 and a second position 206 via an axis 208. As described herein, the sensor hub 202-1, 202-2 can be a single device or enclosure that includes a plurality of sensors such as a camera, a microphone, an infrared sensor, and/or a motion sensor. The sensor hub 202-1, 202-2 can be a single device that is moveable from a first position 204 represented as sensor hub 202-1 to a second position 206 represented as sensor hub 202-2.

In some examples, the device 200 can include a sensor hub bay 220 to receive the sensor hub 202-1, 202-2 when the sensor hub 202-1, 202-2 is in the second position 206. In some examples, the sensor hub bay 220 can be an aperture or pocket within an electrical device to surround the sensor hub 202-2 in the second position 206. In some examples, the sensor hub bay 220 can be a slot that can cover a first side of the sensor hub 202-1, 202-2 and a second side of the sensor hub 202-1, 202-2. For example, the sensor hub bay 220 can cover a side of the sensor hub 202-1, 202-2 that includes the plurality of sensors.

In some examples, the sensor hub 202-1, 202-2 can activate the power switch 210 when the sensor hub 202-1, 202-2 is in the first position 204 and can deactivate the power switch 210 when the sensor hub 202-1, 202-2 is in the second position 206. For example, the power switch 210 can be an electromechanical switch that can include a button to alter a state of the power switch 210. In this example, the button can be depressed by a portion of the sensor hub 202-2 to deactivate the power switch 210 in the second position 206. In this example, the button can be released when the sensor hub 202-1 is in the first position 204. In this way, moving the sensor hub 202-1, 202-2 from the second position 206 to the first position 204 can activate the power switch 210 to provide power to the sensor hub 202-1, 202-2.

In some examples, the power switch 210 can include a button that is depressed when the sensor hub 202-1, 202-2 is in the first position 204 to activate the power switch 210. In these examples, the button of the power switch 210 can be released when the sensor hub 202-1, 202-2 is in the second position 206 to deactivate the power switch 210. As described herein, the power switch 210 can allow electrical power to pass through the power switch 210 when the power switch 210 is activated and prevent electrical power from passing through the power switch 210 when the power switch 210 is deactivated.

In some examples, the device 200 can physically disconnect power to the sensor hub 202-1, 202-2 when the power switch 210 is deactivated. As used herein, physically disconnecting power to the sensor hub 202-1, 202-2 includes disconnecting an electrical coupling between the sensor hub 202-1, 202-2 and a power supply or power source. In another example, physically disconnecting power to the sensor hub 202-1, 202-2 includes physically breaking an electrical connection that is providing electrical power to the sensor hub 202-1, 202-2. In some examples, the power switch 210 can be an electrical switch that his not coupled to a processing resource of the electrical device and may only be activated or deactivated by physical contact with the sensor hub 202-1, 202-2. For example, the power switch 210 may not be communicatively coupled to other devices. As used herein, communicatively coupled includes a connection that allows communication between devices. In this way, the device 200 can prevent an unwanted user from accessing the sensor hub 202-1, 202-2 when the sensor hub 202-1, 202-2 is in the second position 206.

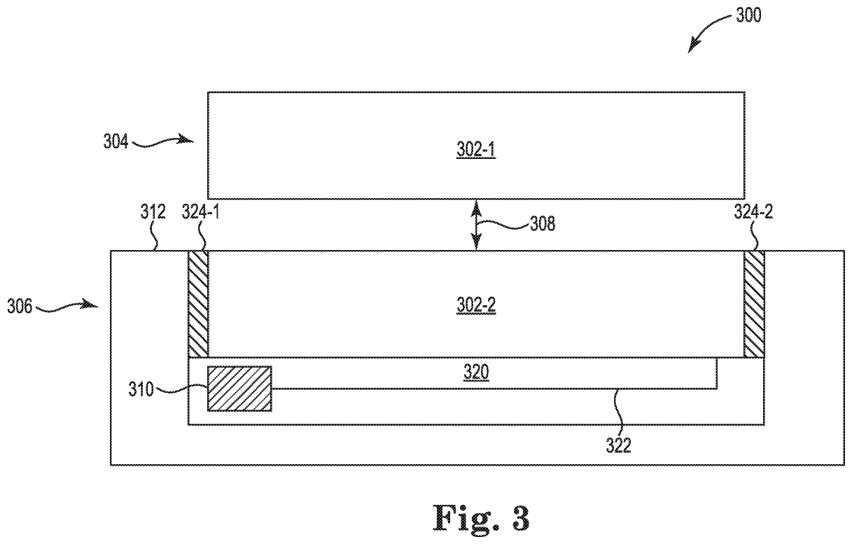

FIG. 3 illustrates an example device 300 for a sensor hub switch consistent with the present disclosure. In some examples, the device 300 can include a sensor hub 302-1, 302-2 that can be moveable between a first position 304 and a second position 306 along an axis 308. As described herein, the sensor hub 302-1, 302-2 can be a single device or enclosure that includes a plurality of sensors. In some examples, the sensor hub 302-1 can be in an active position at the first position 304 and the sensor hub 302-2 can be in an inactive position at the second position 306.

In some examples, the sensor hub 302-1, 302-2 can be coupled to an electrical device 312. In some examples, the electrical device 312 can be a computing device or monitor coupled to a computing device. For example, the electrical device 312 can be a laptop computing device with a display that includes a sensor hub bay 320. In this example, the sensor hub bay 320 can be an aperture within the enclosure of the display to receive the sensor hub 302-1, 302-2.

In some examples, the sensor hub bay 320 can include an actuator 324-1, 324-2 to move the sensor hub 302-1, 302-2 from the first position 304 to the second position 306 and/or move the sensor hub 302-1, 302-2 from the second position 306 to the first position 304. For example, the actuator 324-1, 324-2 can include rails to couple within the sensor hub bay 320 and coupled to an edge or side of the sensor hub 302-1, 302-2. In this example, the rails can allow the sensor hub 302-1, 302-2 to more easily move between the first position 304 and the second position 306. In some examples, the actuator 324-1, 324-2 can include an actuator with mechanical energy to move the sensor hub 302-1, 302-2 from the second position 306 to the first position 304 when the sensor hub 302-1, 302-2 is released from the sensor hub bay 320. For example, the actuator 324-1, 324-2 can include a spring loaded mechanism to provide a force on the sensor hub 302-2 in the second position 306 to move the sensor hub 302-1 to the first position 304 via the axis 308.

In some examples, the sensor hub bay 320 can include a power switch 310 that can be coupled to a power supply of the electrical device 312. For example, the electrical device 312 can include a power supply that converts power from an electrical outlet to be used by the electrical device 312. In this example, the power switch 310 can receive power from the power supply of the electrical device 312. In some examples, the power switch 310 can be coupled to the sensor hub 302-1, 302-2 to provide power to the sensor hub 302-1, 302-2 when the power switch 310 is activated and restrict power to the sensor hub 302-1, 302-2 when the power switch 310 is deactivated. In some examples, the power switch 310 can be coupled to the sensor hub 302-1, 302-2 via a connection 322. In some examples, the connection 322 can be a flexible connection that can move with the sensor hub 302-1, 302-2 when the sensor hub 302-1, 302-2 moves from the second position 306 to the first position 304.

As described herein, the power switch 310 can be a contact switch that can be activated and deactivated by physical contact with a button coupled to the power switch 310. As used herein, physical contact can include a physical interaction between a surface of the power switch 310 and a surface of the sensor hub 302-2. In some examples, the button of the power switch 310 can be depressed with physical contact by a portion of the sensor hub 302-1, 302-2 to activate and/or deactivate the power switch 310. For example, the sensor hub 302-2 in the second position 306 can depress the power switch 310 to deactivate the power switch 310 and physically disconnect power from the sensor hub 302-2 in the second position 306. In this example, the sensor hub 302-1 in the first position 304 can be out of contact with the button of the power switch 310 to activate the power switch 310 and provide power to the sensor hub 302-1 in the first position 304.

In some examples, the device 300 can physically disconnect power to the sensor hub 302-1, 302-2 when the power switch 310 is deactivated. In this way, the device 300 can prevent an unwanted user from accessing the sensor hub 302-1, 302-2 when the sensor hub 302-1, 302-2 is in the second position 306.

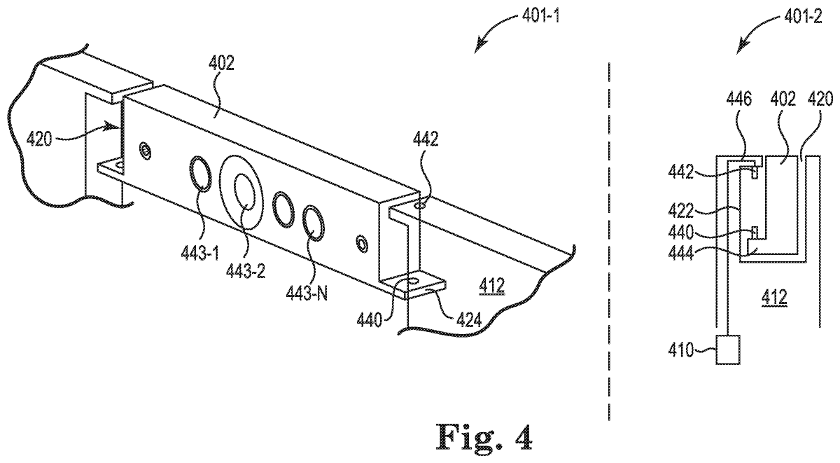

FIG. 4 illustrates an example system 401-1, 401-2 for a sensor hub switch consistent with the present disclosure. FIG. 4 illustrates a system 401-1 from a front view to illustrate the plurality of sensors 443-1, 443-2, 443-N positioned within the sensor hub bay 420. In addition, FIG. 4 illustrates a system 401-2 from a side view to illustrate the sensor hub 402 positioned within the sensor hub bay 420. In some examples, the system 401-1, 401-2 can illustrate when the sensor hub 402 is in a deactivated position. For example, the system 401-1, 401-2 can illustrate the sensor hub 402 positioned within the sensor hub bay 420, when the sensor hub 402 is in a second position, and/or when the sensor hub 402 is surrounded by the electrical device 412.

As described herein, the sensor hub 402 can be a device that includes a plurality of sensors 443-1, 443-2, 443-N. In some examples, the sensor 443-1 can be a microphone, the sensor 443-2 can be a video camera, and the sensor 443-N can be an infrared sensor. In some examples, the plurality of sensors 443-1, 443-2, 443-N can be covered by the enclosure of the electrical device 412. In some examples, the system 401-1, 401-2 can include a power switch 410 that can be coupled to a button 442. In some examples, the sensor hub 402 can include a lip portion 444 that can depress the button 442 to activate the power switch 410 when the lip portion 444 makes physical contact with the button 442. In some examples, the power switch 410 can physically disconnect the sensor hub 402 from a power supply when the power switch 410 is deactivated. As used herein, physically disconnecting the sensor hub 402 from the power supply includes physically separating an electrical connection to prevent electrical energy to pass from the power supply to the sensor hub 402.

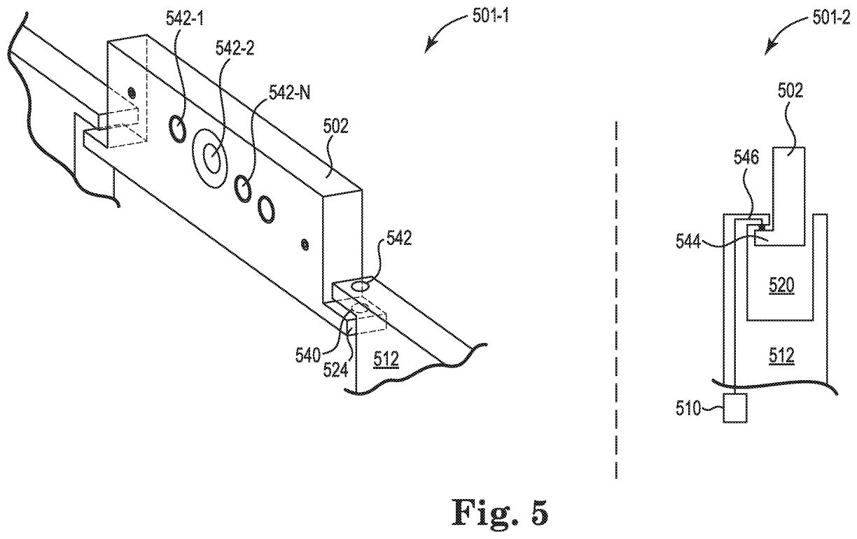

In some examples, the button 442 can be an electrical contact (e.g., pogo electrical contact, etc.) that can make contact with an electrical contact 440 coupled to the lip portion 444 of the sensor hub 402. In this example, the power switch 410 can provide power to the sensor hub 402 when the button 442 is in contact with the electrical contact 440. In these examples, the electrical connection of the sensor hub 402 can be disconnected when the sensor hub 402 is positioned within the sensor hub bay 420. In some examples, the sensor hub 402 can include a lip portion 444 to prevent the sensor hub 402 from extending past an active position as illustrated in FIG. 5 (e.g., the first position).

In some examples, the sensor hub 402 can be coupled to the sensor hub bay 420 via an actuator 424. As described herein, the actuator 424 can allow the sensor hub 402 to move from a first position outside the sensor hub bay 420 to a second position within the sensor hub bay 420. In some examples, the actuator 424 can be a spring loaded mechanism for providing a force to move the sensor hub 402 from the second position to the first position.

In some examples, the system 401-1, 401-2 can physically disconnect power to the sensor hub 402 when the power switch 410 is deactivated. In this way, the system 401-1, 401-2 can prevent an unwanted user from accessing the sensor hub 402 when the sensor hub 402 is in the second position within the sensor hub bay 420. As described herein, the system 401-1, 401-2 can be utilized to provide additional security from unauthorized users by utilizing a power switch 410 to physically disconnect a power source from the sensor hub 402 when the sensor hub 402 removes the electrical contact 440 from the button 442. Utilizing physical contact of the sensor hub 402 to activate and deactivate the electrical power to the sensor hub 402 can prevent remote users from activating the sensor hub 402 when electrical power is not provided to the sensor hub 402.

FIG. 5 illustrates an example system 501-1, 501-2 for a sensor hub switch consistent with the present disclosure. FIG. 5 illustrates a system 501-1 from a front view to illustrate the plurality of sensors 543-1, 543-2, 543-N positioned outside the sensor hub bay 520. In addition, FIG. 5 illustrates a system 501-2 from a side view to illustrate the sensor hub 502 positioned outside the sensor hub bay 520. In some examples, the system 501-1, 501-2 can illustrate when the sensor hub 502 is in an active position. For example, the system 501-1, 501-2 can illustrate the sensor hub 502 positioned outside the sensor hub bay 520 (e.g., when the sensor hub 502 is in a first position, when the sensor hub 502 is exposed from the electrical device 512, etc.). In some examples, the active position can include when the sensor hub 502 is connected to electrical power via the power switch 510 and/or when the sensor hub 502 is positioned outside the sensor hub bay 520, etc.

As described herein, the sensor hub 502 can be a device that includes a plurality of sensors 543-1, 543-2, 543-N. In some examples, the sensor 543-1 can be a microphone, the sensor 543-2 can be a video camera, and the sensor 543-N can be an infrared sensor. In some examples, the plurality of sensors 543-1, 543-2, 543-N can be exposed from the enclosure of the electrical device 512 to allow a user to utilize the plurality of sensors 543-1, 543-2, 543-N. In some examples, the system 501-2 can include a power switch 510 that can be coupled to a button 542. In some examples, the sensor hub 502 can include a lip portion 544 that can depress the button 542 to activate the power switch 510 when the lip portion 544 makes physical contact with the button 542. That is, the lip portion 544 of the sensor hub 502 depresses the power switch 510 via the button 542 within the sensor hub bay 520 to activate the power switch 510 when the sensor hub 502 is in the first position as illustrated in FIG. 5.

In some examples, the button 542 can be an electrical contact (e.g., pogo electrical contact, etc.) that can make contact with an electrical contact 540 coupled to the lip portion 544 of the sensor hub 502. In this example, the power switch 510 can provide power to the sensor hub 502 when the button 542 is in contact with the electrical contact 540. In these examples, the electrical connection of the sensor hub 502 can be connected when the sensor hub 502 is positioned outside the sensor hub bay 520. That is, the sensor hub 502 is in physical contact with the button 542 (e.g., power switch) at the active position (e.g., first position) to activate the power switch 510. In some examples, the sensor hub 502 can include a lip portion 544 to prevent the sensor hub 502 from extending past an active position as illustrated in FIG. 5 (e.g., the first position).

In some examples, the sensor hub 502 can be coupled to the sensor hub bay 520 via an actuator 524. As described herein, the actuator 524 can allow the sensor hub 502 to move from a first position outside the sensor hub bay 520 to a second position within the sensor hub bay 520. In some examples, the actuator 524 can be a spring loaded mechanism for providing a force to move the sensor hub 502 from the second position to the first position.

In some examples, the system 501-1, 501-2 can physically disconnect power to the sensor hub 502 when the power switch 510 is deactivated. In this way, the system 501-1, 501-2 can prevent an unwanted user from accessing the sensor hub 502 when the sensor hub 502 is in the second position within the sensor hub bay 520. FIG. 5 can illustrate when the sensor hub 502 is in an active position. As described herein, the active position can include when the sensor hub 502 is provided electrical power through the power switch 510. In this way, the sensor hub 502 can be utilized by a computing device when the sensor hub 502 is in the active position.

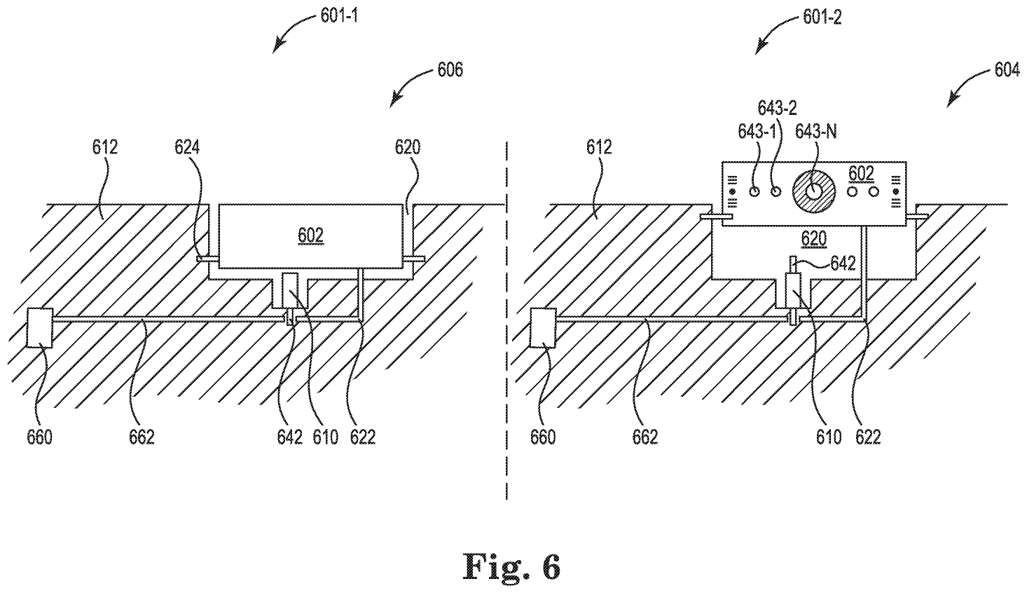

FIG. 6 illustrates an example system 601-1, 601-2 for a sensor hub switch consistent with the present disclosure. In some examples, the system 601-1 can illustrate when the sensor hub 602 is in an active position 604 (e.g., when the sensor hub 602 is connected to electrical power via the power switch 610, when the sensor hub 602 is positioned outside the sensor hub bay 620, etc.) and system 601-2 can illustrate when the sensor hub 602 is in a deactivated position 606 (e.g., when the sensor hub 602 is positioned within the sensor hub bay 620, etc.).

For example, the system 601-2 can illustrate the sensor hub 602 positioned outside the sensor hub bay 620 (e.g., when the sensor hub 602 is in a first position, when the sensor hub 602 is exposed from the electrical device 612, etc.) at the active position 604. In another example, the system 601-1 can illustrate the sensor hub 602 positioned within the sensor hub bay 620 (e.g., when the sensor hub 602 is in a second position, when the sensor hub 602 is covered by the electrical device 612, etc.) at the deactivated position 606. In some examples, a portion of the sensor hub bay 620 covers a sensor or plurality of sensors 643-1, 643-2, 643-N of the sensor hub 602 when the sensor hub 602 is in the deactivated position 606 (e.g., second position).

As described herein, the sensor hub 602 can be a device that includes a plurality of sensors 643-1, 643-2, 643-N. In some examples, the plurality of sensors 643-1, 643-2, 643-N can include a microphone, a video camera, and/or an infrared sensor. In some examples, the plurality of sensors 643-1, 643-2, 643-N can be exposed from the enclosure of the electrical device 612 to allow a user to utilize the plurality of sensors 643-1, 643-2, 643-N in the active position 604. In other examples, the plurality of sensors 643-1, 643-2, 643-N can be covered by the enclosure of the electrical device 612 in the deactivated position 606. In some examples, the enclosure of the electrical device 612 maintains power from a power supply 660 when the power switch 610 is deactivated to restrict power to the sensor hub 602. For example, the electrical device can be a laptop computing device that can utilize power from the power supply 660 even when the power switch 610 is deactivated. In this way, a user can utilize the laptop computing device when the sensor hub 602 is in the deactivated position 606.

In some examples, the system 601-1, 601-2 can include a power switch 610 that can be coupled to a button 642. In some examples, the sensor hub 602 can depress the button 642 to deactivate the power switch 610 when the sensor hub 602 makes physical contact with the button 642 in the deactivated position 606. That is, the sensor hub 602 is in physical contact with the power switch 610 at the deactivated position 606 (e.g., second position) to deactivate the power switch 610 via the button 642. In another example, the sensor hub 602 can release the button 642 to activate the power switch 610 when the sensor hub is in the active position 604.

In some examples, the power switch 610 can be coupled to a power supply 660 of the electrical device 612. As described herein, the electrical device 612 can be a computing device and/or a display coupled to a computing device. The electrical device 612 can include a power supply 660 to convert power from a power source (e.g., electrical grid, battery, etc.) to a voltage and/or current that can be utilized by the electrical device 612. In some examples, the power supply 660 can be utilized to provide electrical power to the power switch 610 via connection 662. As described herein, the sensor hub bay 602 is positioned within an electrical device 612 that provides power to the power switch 610 via the power supply 660.

In some examples, the power supply 660 can provide power to the sensor hub 602 when the power switch 610 is activated. For example, the power switch 610 in an active position as illustrated by the active position 604 can receive electrical power from the power supply 660 and allow power to pass through the power switch 610 to connection 622 coupled to the sensor hub 602. That is, an electrical connection between the sensor hub 602 and a power supply 660 is closed (e.g., closed circuit, connected circuit, etc.) when the power switch 610 is activated by the sensor hub. Conversely, the power switch 610 in a deactivated position as illustrated by the deactivated position 606 can receive electrical power from the power supply 660 and prevent power from passing through the power switch 610 to the sensor hub. That is, an electrical connection between the sensor hub 602 and the power supply 660 is open (e.g., open circuit, disconnected circuit, etc.) when the power switch 610 is deactivated by the sensor hub 602.

In some examples, the sensor hub 602 can be coupled to the sensor hub bay 620 via an actuator 624. As described herein, the actuator 624 can allow the sensor hub 602 to move from a first position (e.g., active position 604) outside the sensor hub bay 620 to a second position (e.g., deactivated position 606) within the sensor hub bay 620. In some examples, the actuator 624 can be a spring loaded mechanism for providing a force to move the sensor hub 602 from the deactivated position 606 to the active position 604.

In some examples, the system 601-1 can physically disconnect power to the sensor hub 602 when the power switch 610 is deactivated. In this way, the system 601-1 can prevent an unwanted user from accessing the sensor hub 602 when the sensor hub 602 is in the deactivated position 606 within the sensor hub bay 620. FIG. 6 can illustrate the deactivated position 606 and the active position 604 of the sensor hub 602. As described herein, the deactivated position 606 can allow the sensor hub 602 to make a physical contact with a power switch 610 to break an electrical connection and prevent electrical power from being provided to the sensor hub 602. The active position 604 can remove the physical contact with the power switch 610 to allow electrical power to be provided to the sensor hub 602.

The above specification describes sensor hub switches that can be utilized with devices such as a sensor hub that can moved from an active position for use to a deactivated position for storage. The devices such as a sensor hub can be deactivated by a physical switch when the devices are in the deactivated position. In this way, the devices can be additionally protected from unauthorized remote users since the remote user would not be able to activate or deactivate a physical switch from a remote location. In some examples, the physical switch can be communicatively removed or not connected to a processing resource such that a remote user would not be able to bypass the physical switch using the processing resource. In this way, the unauthorized remote user would not be capable of activating sensors or other devices when the devices are in the deactivated position.

The above specification, examples and data provide a description of the methods and applications, and use of the system and method of the present disclosure. Since many examples can be made without departing from the spirit and scope of the system and method of the present disclosure, this specification merely sets forth some of the many possible example configurations and implementations.

What is claimed:

1. A device, comprising:
a sensor hub moveable between a first position and a second position; and
a power switch to be deactivated by the sensor hub when the sensor hub is at the second position.

2. The device of claim 1, wherein an electrical connection between the sensor hub and a power supply is closed when the power switch is activated by the sensor hub.

3. The device of claim 2, wherein an electrical connection between the sensor hub and the power supply is open when the power switch is deactivated by the sensor hub.

4. The device of claim 1, wherein the sensor hub is in physical contact with the power switch at the second position to deactivate the power switch.

5. The device of claim 1, wherein the sensor hub is in physical contact with the power switch at the first position to activate the power switch.

6. A system, comprising:
a sensor hub bay that includes a power switch; and
a sensor hub moveable between a first position outside the sensor hub bay and a second position within the sensor hub bay, wherein the sensor hub deactivates the power switch when the sensor hub is in the second position.

7. The system of claim 6, wherein a portion of the sensor hub depresses the power switch within the sensor hub bay to deactivate the power switch when the sensor hub is in the second position.

8. The system of claim 6, wherein the sensor hub includes a lip portion to prevent the sensor hub from extending past the first position.

9. The system of claim 8, wherein the lip portion of the sensor hub depresses the power switch within the sensor hub bay to activate the power switch when the sensor hub is in the first position.

10. The system of claim 6, wherein the sensor hub bay is positioned within an electrical device that provides power to the power switch.

11. The system of claim 6, wherein a portion of the sensor hub bay covers a sensor of the sensor hub when the sensor hub is in the second position.

12. A device, comprising:
an enclosure with a sensor hub bay that includes a power switch;
a sensor hub that includes a plurality of sensors electrically coupled to the power switch; and
an actuator to move the sensor hub between a first position outside the sensor hub bay and a second position within the sensor hub bay such that the sensor hub interacts with the power switch to deactivate the power switch in the second position and activate the power switch in the first position.

13. The device of claim 12, wherein the plurality of sensors are covered by the enclosure when the sensor hub is at the second position.

14. The device of claim 12, wherein the power switch physically disconnects the sensor hub from a power supply when the power switch is deactivated.

15. The device of claim 12, wherein the enclosure maintains power from a power supply when the power switch is deactivated to restrict power to the sensor hub.
